(19) United States
(12) Patent Application Publication
(10) Pub. No.: US 2026/0329024 A1
(43) Pub. Date: Oct. 22, 2026

(54) COMPUTING MODULE AND COMPUTING APPARATUS INCLUDING THE SAME

(71) Applicant: Omattrix Ltd., Co., Santa Clara, CA (US)

(72) Inventors: Lung Kevin Law, Santa Clara, CA (US); Tom Wu, Santa Clara, CA (US); Carl Bai, Santa Clara, CA (US)

(73) Assignee: Omattrix Ltd., Co., Santa Clara, CA (US)

(21) Appl. No.: 19/313,307

(22) Filed: Aug. 28, 2025

(51) Int. Cl. G02B 6/42; G02B 1/04; G02B 6/43

(52) U.S. Cl. CPC G02B 6/4206; G02B 6/4274; G02B 6/43; G02B 1/041

(57) ABSTRACT

The present disclosure relates to chip interconnect technology, and more particularly, to a computing module constructed using the chip interconnect technology and a computing apparatus comprising the computing module. A computing module according to one aspect of the present disclosure comprises a substrate, a plurality of data processing units, one or more optical connectors, and a signal switching unit. In the computing module, the data processing units are disposed on a surface of or inside the substrate, and the optical connectors are disposed on the surface of the substrate. The signal switching unit is disposed on the surface of or inside the substrate, and is connected to the data processing units and the optical connectors via a first transmission path and a second transmission path, respectively, so as to implement a first signal transmission between the signal switching unit and the data processing units, as well as a second signal transmission between the signal switching unit and the optical connectors. The first signal transmission is electrical signal transmission or optical signal transmission, and the second signal transmission is optical signal transmission.

### TECHNICAL FIELD

The present disclosure relates to chip interconnect technology, and more particularly, to a computing module constructed by using the chip interconnect technology and a computing apparatus including the computing module.

### BACKGROUND

Large language models (LLMs) are undergoing leap-forward development: their parameter scale has soared from billions to trillions, the volume of training data has surpassed the trillion-token mark, and the computing capacity required for a single complete training run has reached a staggering 1023 FLOPS. The core challenge in training large models lies in the efficient flow of data between computing nodes. Taking a complex-model parallel-processing scenario as an example, it requires sharding and storing model parameters on different nodes. The latency of inter-layer data transmission directly impacts pipeline efficiency, becoming a key factor that constrains the scale of model parallelism.

### SUMMARY

According to one aspect of the present disclosure, there is provided a computing module, the computing module comprising: a substrate; a plurality of data processing units disposed on a surface of or inside the substrate; one or more optical connectors disposed on the surface of the substrate; and a signal switching unit disposed on the surface of or inside the substrate, the signal switching unit being connected to the data processing units and the optical connectors respectively via a first transmission path and a second transmission path, so as to implement a first signal transmission between the signal switching unit and the data processing units as well as a second signal transmission between the signal switching unit and the optical connectors, wherein the first signal transmission can be electrical signal transmission or optical signal transmission, and the second signal transmission can be optical signal transmission.

According to another aspect of the present disclosure, there is provided a computing apparatus comprising a plurality of computing modules. In the computing apparatus, each of the computing modules comprises: a substrate; a plurality of data processing units disposed on a surface of or inside the substrate; one or more optical connectors disposed on the surface of the substrate; and a signal switching unit disposed on the surface of or inside the substrate, the signal switching unit being connected to the data processing units and the optical connectors respectively via a first transmission path and a second transmission path, so as to implement a first signal transmission between the signal switching unit and the data processing units as well as a second signal transmission between the signal switching unit and the optical connectors, wherein the first signal transmission can be electrical signal transmission or optical signal transmission, and the second signal transmission can be optical signal transmission.

### BRIEF DESCRIPTION OF DRAWINGS

The above and/or other aspects and advantages of the present disclosure will become clearer and more readily understood from the following description of various aspects in conjunction with the accompanying drawings, in which the identical or similar units are denoted by the same reference numerals. The drawings comprise:

FIGS. 1A-1C are schematic diagrams of a computing module according to one embodiment of the present disclosure.

FIGS. 2A and 2B are schematic diagrams of a computing module according to one embodiment of the present disclosure.

FIGS. 3A-3C are schematic diagrams of a computing module according to one embodiment of the present disclosure.

FIGS. 4A and 4B are schematic diagrams of a computing module according to one embodiment of the present disclosure.

FIG. 5 is a schematic diagram of an optical connector according to one embodiment of the present disclosure.

FIG. 6 is a schematic diagram for implementing dynamic compensation according to one embodiment of the present disclosure.

FIG. 7 is a schematic diagram of computing module interconnection according to one embodiment of the present disclosure.

FIG. 8 is a schematic diagram of computing module interconnection according to one embodiment of the present disclosure.

FIG. 9 is a schematic diagram of an optical connector according to one embodiment of the present disclosure.

FIG. 10 is a schematic diagram of computing module interconnection according to one embodiment of the present disclosure.

FIG. 11 is a schematic diagram of an optical connector according to one embodiment of the present disclosure.

FIGS. 12A and 12B are schematic diagrams of a computing apparatus according to one embodiment of the present disclosure.

FIG. 13 is a schematic diagram of a computing apparatus or an optical interconnect system according to one embodiment of the present disclosure.

### DETAILED DESCRIPTION OF EMBODIMENTS

The present disclosure will be described more fully hereinafter with reference to the accompanying drawings, in which schematic embodiments of the present disclosure are shown. The present disclosure may, however, be embodied in many different forms and should not be construed as limited solely to the embodiments set forth herein. Rather, these embodiments are provided so that the present disclosure will be thorough and complete, and its scope will be fully conveyed to those skilled in the art.

In this specification, the term “comprise” and its analogues should be interpreted as open-ended inclusion, i.e., “comprising but not limited to”; the term “based on” should be interpreted as “based at least in part on”; and the term “one embodiment” or “the embodiment” should be interpreted as “at least one embodiment”. Moreover, the terms “first”, “second”, and “third” are intended for descriptive purposes only and should not be construed as indicating or implying relative importance. Besides, those skilled in the art can combine and composite the different embodiments or examples and the features of the different embodiments or examples described in this specification, provided that no contradictions arise.

In this specification, a phrase such as “component A is disposed on a surface of component B” means that at least a part of component A is located outside the surface of component B; and a phrase such as “component A is disposed inside component B” means that all parts of component A are located inside component B.

In this specification, the term “computing module” refers to a modular unit that integrates multiple circuits or components (e.g., semiconductor chips) to provide data processing, signal switching, and high-speed optical communication interface functions.

In this specification, the term “main surface” refers to a surface of a substrate intended to carry core functional components (e.g., core computing components such as computing chips, memory chips, and in-memory computing chips), which can serve as the primary area for component mounting and signal interconnection.

In this specification, the term “side surface” refers to other surfaces of the substrate apart from the main surface, mainly serving functions such as edge connection, mechanical fixing, and signal transition.

In this specification, the term “optical connection” refers to an associated state capable of transmitting optical signals, formed by the physical alignment of two optical devices (e.g., an optical waveguide and a lens, or a lens and an optical fiber).

In this specification, the term “optical coupling” refers to an energy transfer process when an optical signal is transmitted from one optical device/medium (e.g., an optical waveguide) to another device/medium (e.g., a lens). Typically, the transmission loss of the optical signal in the energy transfer process is measured by “optical coupling efficiency” (optical power entering a receiving end/total power at a transmitting end).

In existing computing modules, transmission paths (e.g., high-speed circuits) are established between data processing units (e.g., computing chips, memory chips, and in-memory computing chips, etc.) to implement data communication therebetween. Due to process and cost constraints, it is usually not feasible to establish transmission paths between all pairs of chips—that is, the scale of interconnection between chips is limited. Accordingly, for two chips that are far apart (e.g., two chips located in the top region along a diagonal of a substrate), the data transmitted between them needs to be relayed through other chips, which will lead to relatively high link loss and latency, especially when the substrate is large and the computing module contains a substantial number of data processing units.

In some embodiments of the present disclosure, a signal switching unit (e.g., a photonic integrated circuit or an optical-switching chip) is introduced into a computing module as a data exchange hub. The signal switching unit is connected, on the one hand, to data processing units, and to optical connectors on the other hand, thereby implementing data communication between the data processing units inside the computing module, as well as data communication between the data processing units and an external system or data processing units in other computing modules. Since all the data processing units are directly connected to the signal switching unit, link loss and latency can be reduced overall, especially when multiple chips work together. For example, in AI training where multiple graphics processing units (GPUs) communicate, the signal switching unit can implement high-speed local interconnection to increase bandwidth. In addition, the star topology architecture with the signal switching unit serving as a central unit facilitates the centralized management of data routing, optimizes resource allocation (e.g., dynamically adjusting data paths based on load to prevent congestion, etc.) and improves overall efficiency—this is particularly important for heterogeneous computing (in which efficient collaboration between different types of chips is required).

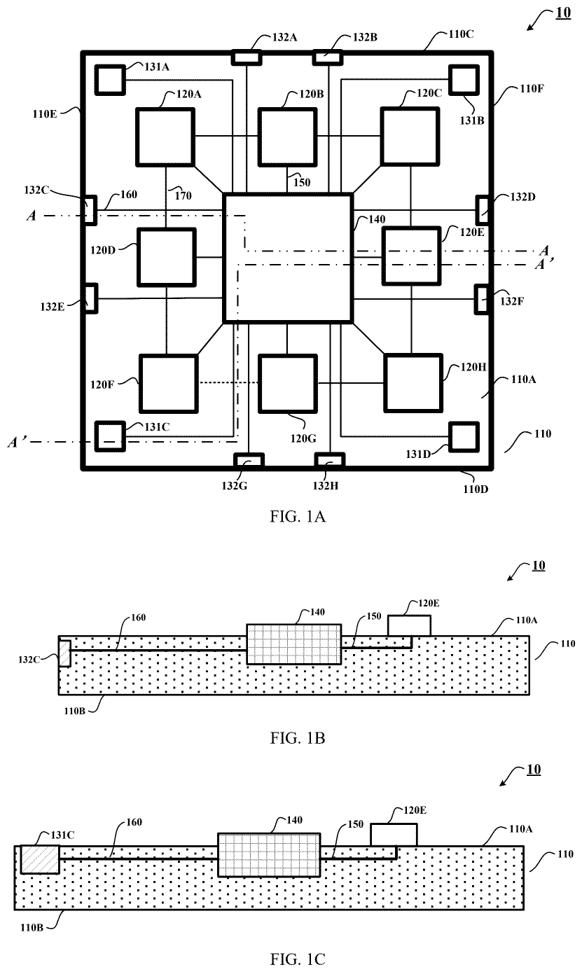

FIGS. 1A-1C are schematic diagrams of a computing module according to one embodiment of the present disclosure, wherein FIG. 1A is a plan view of the computing module shown, FIG. 1B is a cross-sectional view taken along line A-A in FIG. 1A, and FIG. 1C is a cross-sectional view taken along line A′-A′ in FIG. 1A.

Referring to FIG. 1A, a computing module 10, as shown, comprises a substrate 110, data processing units 120A-120H, first optical connectors 131A-131D, second optical connectors 132A-132H, and a signal switching unit 140. In the embodiment shown, the substrate 110 serves as a carrier for carrying the layout and interconnection of various functional units and supporting the integrated deployment of the data processing units 120A-120H, the first optical connectors 131A-131D, the second optical connectors 132A-132H and the signal switching unit 140. Exemplarily, the substrate 110 can be, for example, a glass substrate or a printed circuit board.

As can be seen in conjunction with FIGS. 1A, 1B and 1C, the substrate 110 has a first main surface 110A, a second main surface 110B opposite to the first main surface 110A, a first side surface 110C, a second side surface 110D opposite to the first side surface 110C, a third side surface 110E and a fourth side surface 110F opposite to the third side surface 110E. The signal switching unit 140 is disposed on the first main surface 110A of the substrate 110 and located at the center of the surface, the data processing units 120A-120H are disposed on the first main surface 110A of the substrate 110 and located around the periphery of the signal switching unit 140, the first optical connectors 131A-131D are disposed on the first main surface 110A of the substrate 110 and located at the corners of the surface, and the second optical connectors 132A-132H are disposed on the side surfaces 110C-110F of the substrate 110.

The above arrangement, where the signal switching unit is disposed at the center of the main surface and the data processing units are distributed all around, can significantly shorten the average interconnection distance between the data processing units and the signal switching unit, thereby reducing signal transmission latency (which is positively correlated with distance) and loss (e.g., the loss of PCB trace resistance increases with length). In addition, the optical connectors disposed at the corners of the main surface or on the side surfaces are far from the high-frequency signal area at the center of the main surface of the substrate, which can reduce optical/electrical signal crosstalk and facilitate the access of external optical fibers from the sides or top of the substrate to adapt to high-density rack wiring. Furthermore, by disposing the optical connectors on the side surfaces of the substrate, optical signal access in multiple directions can be supported, thus improving wiring flexibility.

The data processing units 120A-120H, as core computing components, are intended to perform data processing tasks. Exemplarily, each of the data processing units 120A-120H can comprise one of the following chips or various combinations thereof: a computing chip (e.g., a central processing unit (CPU), a graphics processing unit (GPU), an application-specific integrated circuit (ASIC) and a field-programmable gate array (FPGA), etc.), a memory chip (e.g., graphics DRAM (GDDR), high bandwidth memory (HBM) and static random-access memory (SRAM), etc.), as well as an in-memory computing chip.

The first optical connectors 131A-131D and the second optical connectors 132A-132H, as external communication interfaces or optical interconnection interfaces of the computing module 10, support data communication of the signal switching unit 140 and the data processing units 120A-120H with other computing modules or external systems. The first optical connectors 131A-131D and the second optical connectors 132A-132H can be direct-connect optical connectors suitable for direct connection with other optical connectors, the types of which comprise, for example, optical backplane connectors and multi-core direct-connect modules. In addition, the first optical connectors 131A-131D and the second optical connectors 132A-132H can also have a structure suitable for connection with a fiber adapter unit.

As should be noted, although the described embodiment includes both the first and second optical connectors, this is not a necessary configuration. In variations of this embodiment, the computing module can also comprise only the first optical connectors located on the main surface of the substrate or the second optical connectors located on the side surfaces of the substrate. It should further be noted that when the first and second optical connectors adopt a structure suitable for connection with a fiber adapter unit, each optical connector can comprise a plurality of ports to implement optical interconnection between the computing module to which it belongs (or a local computing module) and a plurality of other computing modules.

By disposing the optical connectors on the main and side surfaces, the expansion of the computing module in the vertical direction (the normal direction of the main surface of the substrate) and the horizontal direction (the normal direction of the side surfaces of the substrate) can be achieved, effectively increasing the scale of a single AI computing cluster. In addition, the mixed use of multiple types of the optical connectors can adapt to a variety of application scenarios. For example, for short-distance high-density interconnection, optical backplane connectors and multi-core direct-connect modules can be employed to reduce signal latency, while for long-distance interconnection, a structure suitable for connection with a fiber adapter unit can be adopted to improve the flexibility of expansion.

The signal switching unit 140, as a data exchange hub in the computing module, implements signal transmission through two types of transmission paths. Specifically, as shown in FIGS. 1A-1C, a first transmission path 150 (represented by the solid lines connecting the signal switching unit 140 and the data processing units 120A-120H in the figures) is intended to transmit electrical signals to implement data communication between the signal switching unit and the data processing units. Still refer to FIGS. 1A, 1B, and 1C, a second transmission path 160 (represented by the solid lines connecting the signal switching unit 140 and the first optical connectors 131A-131D and the second optical connectors 132A-132H in the figures) is intended to transmit optical signals to implement data communication of the signal switching unit with the first and second optical connectors.

In this embodiment, the signal switching unit 140 is enabled in the form of a photonic integrated circuit that integrates optoelectronic conversion and optical switching functions. The photonic integrated circuit comprises, for example, a silicon photonic module that integrates optoelectronic conversion and optical switching functions (such as wavelength division multiplexing) and a monolithically integrated full optoelectronic fusion chip that simultaneously implements optoelectronic conversion, optical switching and electrical processing. Alternatively, the signal switching unit 140 can also comprise discrete optoelectronic converter chips and optical-switching chips to implement their respective functions. Examples of the optoelectronic converter chips include, but are not limited to, optical transmitter chips and optical receiver chips, and examples of the optical-switching chips include, but are not limited to, silicon photonic optical-switching chips, planar lightwave circuit optical-switching chips and micro-electro-mechanical system optical-switching chips.

Optionally, in addition to being connected to the signal switching unit 140, the data processing units 120A-120H can also be directly connected to adjacent data processing units via a third transmission path 170 (represented by the solid lines connecting adjacent data processing units in the figure) as shown in FIG. 1A to implement direct data communication therebetween. In the hybrid communication architecture comprising interconnection between the data processing units and the signal switching unit as well as interconnection between the data processing units, on the one hand, communication latency is reduced by the direct connection between the data processing units, and on the other hand, the reliability and fault tolerance of the computing module are improved by providing redundant data transmission paths between the data processing units and between the data processing units and the signal switching unit.

The first transmission path 150, the second transmission path 160, and the third transmission path 170 are formed inside the substrate 110. Optionally, the first transmission path 150 and the third transmission path are high-speed circuits composed of, for example, metal wires, which can be formed by drilling holes, depositing, electroplating metal or the like inside the substrate. Alternatively, the second transmission path 160 is an optical signal transmission structure or an optical waveguide formed inside the substrate, which confines light to a core region through a difference in refractive index and utilizes total internal reflection or mode confinement to achieve low-loss transmission of optical signals. The optical waveguide can be formed, for example, by applying processes such as photolithography or laser direct writing inside the substrate.

In the embodiment shown in FIGS. 1A-1C, a first optical signal from other computing modules or an external system is received at the first optical connectors 131A-131D or the second optical connectors 132A-132H, and is then transmitted to the signal switching unit 140 via the second transmission path 160. At the signal switching unit 140, the first optical signal is converted into a first electrical signal, which is then transmitted to the data processing units 120A-120H at a corresponding address via the first transmission path 150. Exemplarily, the address can be included in the first optical signal and obtained by the signal switching unit 140 through decoding the first optical signal. On the other hand, a second electrical signal from the data processing units 120A-120H is transmitted to the signal switching unit 140 via the first transmission path 150. At the signal switching unit 140, the second electrical signal is converted into a second optical signal, which is then transmitted to the first optical connectors 131A-131D or the second optical connectors 132A-132H at a corresponding address via the second transmission path 160, and is subsequently transmitted to other computing modules or an external system via the latter. In addition, the signal switching unit 140 can also transmit the second electrical signal to the data processing units 120A-120H at a corresponding address via the first transmission path 150. Exemplarily, the address can be included in the second electrical signal or the second optical signal and obtained by the signal switching unit 140 through decoding the second electrical signal or the second optical signal.

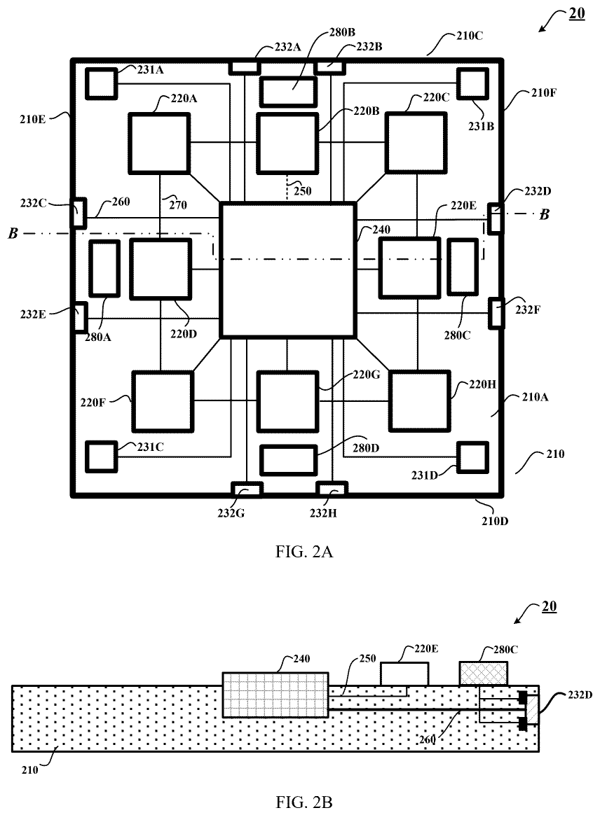

FIGS. 2A and 2B are schematic diagrams of a computing module according to one embodiment of the present disclosure, wherein FIG. 2A is a plan view of the computing module shown, and FIG. 2B is a cross-sectional view taken along line B-B in FIG. 2A. To avoid repetition, the following description of this embodiment will mainly cover content that is different from the embodiment shown in FIGS. 1A-1C.

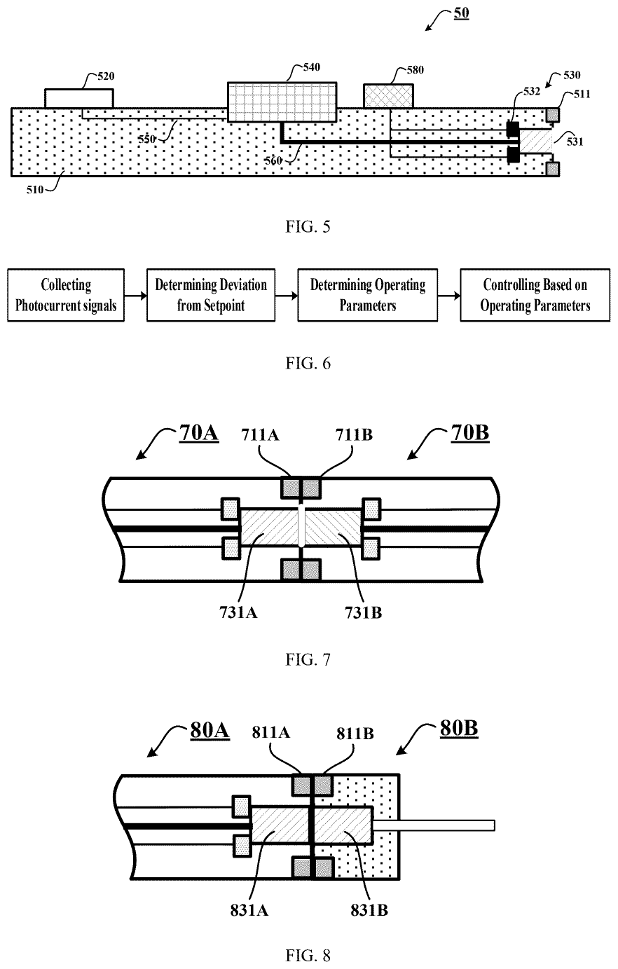

Referring to FIG. 2A, a computing module 20 as shown, in addition to comprising a substrate 210, data processing units 220A-220H, first optical connectors 231A-231D, second optical connectors 232A-232H and a signal switching unit 240, further comprises microcontrollers 280A-280D. The operating parameters (e.g., refractive index or position) of the first optical connectors 231A-231D and the second optical connectors 232A-232H are dynamically adjustable (this type of optical connector is hereinafter referred to as an adjustable optical connector). Each of the optical connectors typically comprises a collimating lens array, and each lens unit in the array corresponds one-to-one with a channel of a waveguide array after fan-out to achieve optical connection between the collimating lens array and the second transmission path or optical waveguide 260. The adjustable optical connector further comprises a control unit (e.g., an electrode or a heater (e.g., a resistance wire)), so that the microcontrollers 280A-280D can adjust the operating parameters of the optical connector by means of the control unit, thereby improving the optical coupling efficiency between an optical waveguide and an optical connector. For example, referring to FIG. 2B, a microcontroller 280C is connected to a control unit (identified by a black box) disposed near a lens unit of a second optical connector 232D, so as to dynamically adjust the operating parameters of the optical connector 232D. The structure and control principle of the adjustable optical connector will be described in detail below with reference to FIGS. 5-11.

In this embodiment, the adjustable optical connectors 231A-231D and 232A-232H are divided into a plurality of optical connector sets, and a corresponding microcontroller 280A-280D is assigned to each of the optical connector sets to perform control operations. Exemplarily, the microcontroller 280A is intended to control the optical connectors 232C and 232E, the microcontroller 280B is intended to control the optical connectors 231A, 232A, 232B and 231B, the microcontroller 280C is intended to control the optical connectors 232D and 232F, and the microcontroller 280D is intended to control the optical connectors 231C, 232G, 232H and 231D. In a variation of this embodiment, a single microcontroller can be employed to exert control over all the adjustable optical connectors.

In this embodiment, the first and second optical connectors can be direct-connect optical connectors suitable for direct connection with other optical connectors, or can adopt a structure suitable for connection with a fiber adapter unit. In addition, a light source can be coupled into the signal switching unit 240 via the optical connectors XXX and then distributed to a corresponding signal processing unit.

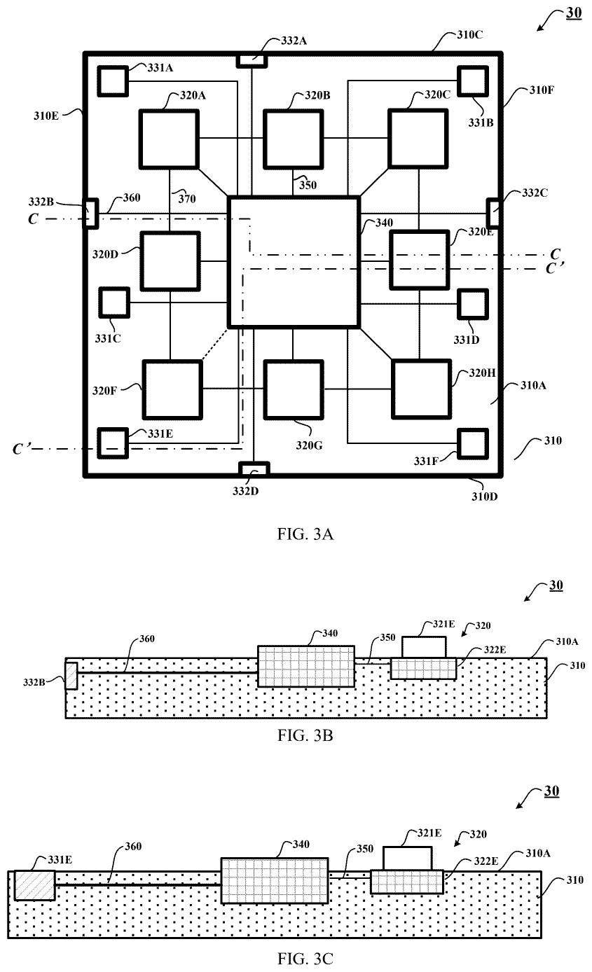

FIGS. 3A-3C are schematic diagrams of a computing module according to one embodiment of the present disclosure, wherein FIG. 3A is a plan view of the computing module shown, FIG. 3B is a cross-sectional view taken along line C-C in FIG. 3A, and FIG. 3C is a cross-sectional view taken along line C′-C′ in FIG. 3A.

As shown in FIG. 3A~3C, a computing module 30 comprises a substrate 310, data processing units 320A-320H, first optical connectors 331A-331F, second optical connectors 332A-332D, and a signal switching unit 340. In the embodiment shown, the substrate 310 is intended to carry the layout and interconnection of various functional units. Similarly, the substrate 310 can be, for example, a glass substrate or a printed circuit board.

Referring to FIGS. 3A-3C, the signal switching unit 340 is disposed on a first main surface 310A of the substrate 310 and located at the center of the surface, the data processing units 320A-320H are disposed on the first main surface 310A of the substrate 310 and located around the periphery of the signal switching unit 340, the first optical connectors 331A-331F are disposed on the first main surface 310A of the substrate 310 and located outside the data processing units 320A-320H, and the second optical connectors 332A-332D are disposed on the side surfaces 310C-310F of the substrate 310.

Different from the embodiments shown in FIGS. 1A-1C and 2A-2B, in this embodiment, each of the data processing units 320A-320H, in addition to comprising core computing components such as a computing chip, a memory chip and an in-memory computing chip, further comprises an optoelectronic converter chip for converting an optical signal from the signal switching unit into an electrical signal suitable for processing by the core computing components, and for converting an electrical signal from the core computing components into an optical signal suitable for processing by the signal switching unit. Taking a data processing unit 320E as an example, as shown in FIGS. 3B and 3C, a core computing component 321E is disposed on the first main surface 310A of the substrate 310, and an optoelectronic converter chip 322E is located below the core computing component 321E and interconnected with the core computing component 321E. In addition, the optoelectronic converter chip 322E is further connected to the signal switching unit 340 via a first transmission path 350. In some specific implementations, the core computing component 321E and the optoelectronic converter chip 322E can be packaged together using various technologies to obtain a multi-chip integrated component or a heterogeneously integrated chip.

Optionally, in addition to being connected to the signal switching unit 340, the optoelectronic converter chips of the data processing units 320A-320H can also be directly connected to the optoelectronic converter chips of adjacent data processing units via a third transmission path 370 (represented by the solid lines connecting adjacent data processing units in the figure) to implement direct data communication therebetween.

In this embodiment, as external communication interfaces or optical interconnection interfaces of the computing module 30, the first optical connectors 331A-331F and the second optical connectors 332A-332D are intended to implement data communication of the signal switching unit 340 and the data processing units 320A-320H with other computing modules or external systems. Similar to the foregoing embodiments, the first optical connectors 331A-331F and the second optical connectors 332A-332D can be direct-connect optical connectors or have a structure suitable for connection with a fiber adapter unit. In addition, the computing module 30 can also comprise only the first optical connectors located on the main surface of the substrate or the second optical connectors located on the side surfaces of the substrate. Furthermore, when the optical connectors adopt a structure suitable for connection with a fiber adapter unit, they can comprise a plurality of ports to implement optical interconnection between the local computing module and a plurality of other computing modules.

Referring to FIGS. 3A-3C, in this embodiment, the signal switching unit 340 and the data processing units 320A-320H transmit optical signals to each other via a first transmission path 350 (represented by the solid lines connecting the signal switching unit 340 and the data processing units 320A-320H in the figure) to implement data communication therebetween. In addition, the signal switching unit 340 and the first optical connectors 331A-331F and the second optical connectors 332A-332D transmit optical signals to each other via a second transmission path 360 (represented by the solid lines connecting the signal switching unit 340 and the first optical connectors 331A-331F and the second optical connectors 332A-332D in the figure) to implement data communication therebetween.

In this embodiment, the signal switching unit 340 is enabled in the form of an optical-switching chip. Examples of the optical-switching chip include, but are not limited to, a silicon photonic optical-switching chip, a planar lightwave circuit optical-switching chip and a micro-electro-mechanical system optical-switching chip.

As shown in FIGS. 3B and 3C, the first transmission path 350, the second transmission path 360 and the third transmission path 370 are formed inside the substrate 310. Likewise, the first transmission path 350, the second transmission path 360 and the third transmission path 370 can be optical signal transmission structures or optical waveguides formed inside the substrate.

In the embodiment shown in FIGS. 3A-3C, a third optical signal from other computing modules or an external system is received at the first optical connectors 331A-331F or the second optical connectors 332A-332D, and is then transmitted to the signal switching unit 340 via the second transmission path 360. The third optical signal is relayed by the signal switching unit 340 to the data processing units 320A-320H at a corresponding address via the first transmission path 350. Exemplarily, the address can be included in the third optical signal and obtained by the signal switching unit 340 through decoding the third optical signal. On the other hand, a fourth optical signal from the data processing units 320A-320H is transmitted to the signal switching unit 340 via the first transmission path 350. At the signal switching unit 340, the fourth optical signal can be relayed to the first optical connectors 331A-331F or the second optical connectors 332A-332D at a corresponding address via the second transmission path 360, and then transmitted to other computing modules or an external system via the latter. In addition, the signal switching unit 340 can also relay the fourth optical signal to the data processing units 320A-320H at a corresponding address via the first transmission path 350. Exemplarily, the address can be included in the fourth optical signal and obtained by the signal switching unit 340 through decoding the fourth optical signal.

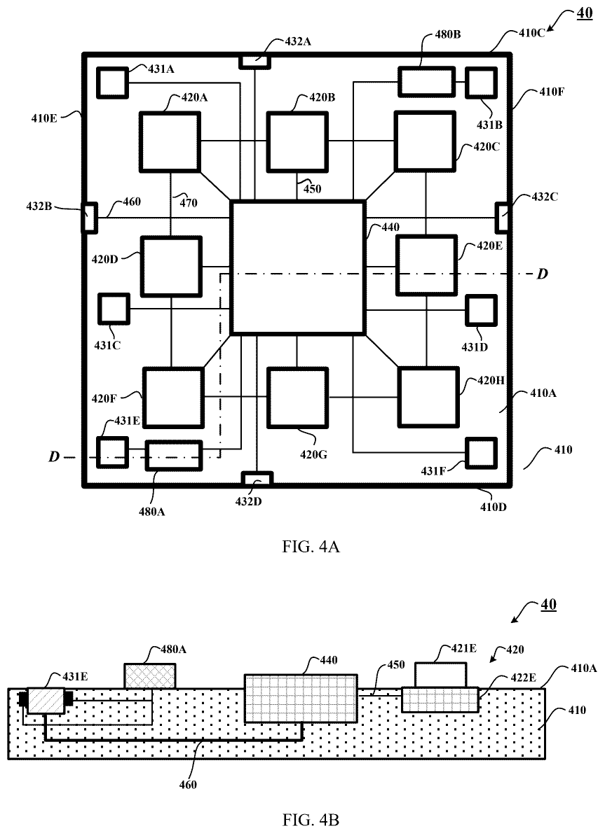

FIGS. 4A and 4B are schematic diagrams of a computing module according to one embodiment of the present disclosure, wherein FIG. 4A is a plan view of the computing module shown, and FIG. 4B is a cross-sectional view taken along line D-D in FIG. 4A. To avoid repetition, the following description of this embodiment will mainly cover content that is different from the embodiment shown in FIGS. 3A-3C.

Referring to FIG. 4A, a computing module 40 as shown, in addition to comprising a substrate 410, data processing units 420A-420H, first optical connectors 431A-431D, second optical connectors 432A-432H and a signal switching unit 440, also comprises microcontrollers 480A and 480B. In addition, the first optical connectors 431A-431D and the second optical connectors 432A-432H are adjustable optical connectors, and a microcontroller 450 adjusts the operating parameters of these optical connectors by means of a control unit, thereby improving the optical coupling efficiency between an optical waveguide and an optical connector. For example, referring to FIG. 4B, the microcontroller 480A is connected to a control unit (identified by a black box) disposed near a lens unit of the second optical connector 431E, so as to dynamically adjust the operating parameters of the optical connector 431E. The structure and control principle of the adjustable optical connector will be described in detail below with reference to FIGS. 5-11.

As should be noted, in the embodiments described above with reference to FIGS. 1A-4B, the manner in which the data processing units, the first optical connectors, the second optical connectors and the signal switching unit are disposed on the substrate is merely exemplary. For example, the signal switching unit and the data processing units can be disposed inside the substrate. As another example, the data processing units, the signal switching unit, and the first optical connectors can be disposed on different main surfaces. As yet another example, the signal switching unit may be disposed at a corner of one of the main surfaces of the substrate, while the data processing units and the first optical connectors are disposed in other areas of the same main surface.

FIG. 5 is a schematic diagram of an optical connector according to one embodiment of the present disclosure. The optical connector as shown can be disposed, as a second optical connector, on the side surface of the substrate of the computing module described above.

In a computing module 50 shown in FIG. 5, optical signal transmission is implemented between a signal switching unit 540 and an optical connector 530 via an optical waveguide 560, and electrical or optical signal transmission is implemented between the signal switching unit 540 and a signal processing unit 520 via a first transmission path 550. In this specification, unless otherwise specified, the transmission of optical signals typically covers bidirectional and unidirectional transmission. The optical waveguide 560 is typically composed of a plurality of parallel optical transmission channels (i.e., in the form of a “waveguide array”, of which only one channel is shown in FIG. 5), wherein each waveguide corresponds to one wavelength or one data channel. The end of the optical waveguide 560 comprises a fan-out region that functions to “expand” a densely arranged multi-channel waveguide array into a sparsely arranged multi-channel waveguide array that matches a fiber adapter unit (FAU). This is essentially a spatial reconstruction of the waveguide array—by designing the path of each waveguide (e.g., bending, bifurcating, or merging at a graded angle), the originally compact array is gradually spaced apart, eventually corresponding one-to-one with the channels of the fiber array.

The optical connector 530 comprises a collimating lens array 531 and a control unit 532. It should be noted that the collimating lens array 531 comprises a plurality of lens units, and FIG. 5 shows only one of the lens units and its corresponding control unit. By disposing the collimating lens array 531 in the fan-out region of the optical waveguide 560 and making each of the lens units correspond one-to-one with a channel of the waveguide array after fan-out, an optical connection between the collimating lens array 531 and the optical waveguide 560 is achieved. The function of the lens unit is to collimate the divergent light fanned out from the waveguide and expand the optical mode field.

In this embodiment, the lens units of the collimating lens array 531 are made of a polymer material having an electro-optic property or a thermo-optic property, and the refractive index of these materials will change with the electric field applied thereto or the temperature of the material. The types of the polymer material comprise, for example, but are not limited to, host-guest type, side-chain type, main-chain type, and cross-linked type. For a material with an electro-optic property, its refractive index is changed by controlling the electric field applied to the lens units of the collimating lens array 531, so as to dynamically compensate for the loss of optical coupling efficiency caused by various factors (including but not limited to assembly tolerances, performance degradation of components of the computing module over their entire life cycle, and temperature fluctuations, etc.) or to improve the optical coupling efficiency. Similarly, for a material with a thermo-optic property, its refractive index is changed by controlling the temperature of the lens units of the collimating lens array 531, so as to improve the optical coupling efficiency between an optical waveguide and an optical interconnect unit.

In this embodiment, the control unit 532 in the form of an electrode or a heater is disposed near the collimating lens array 531 to apply an electric field to or heat the lens units. Exemplarily, as shown in FIG. 5, the electrode or heater may be arranged around each of the lens units of the collimating lens array 531, thereby implementing adjustment of the refractive index of a single lens unit. The control unit 532 is controlled by a microcontroller 580, and the microcontroller may be disposed on a surface of or inside a substrate 510 and is electrically connected to the control unit 532.

FIG. 6 is a schematic diagram for implementing dynamic compensation according to one embodiment of the present disclosure. As shown in FIG. 6, a monitor photodetector (MPD) is intended to collect a photocurrent signal at an optical coupling region of the signal switching unit, the signal corresponding to the intensity or power of an optical signal entering an optical waveguide from a collimating lens array. A microcontroller determines a degree of deviation of the intensity of the optical signal entering the optical waveguide from a setpoint (e.g., a design value) based on the collected photocurrent signal (which can serve to indicate the optical coupling efficiency between an optical waveguide and a connector), and determines operating parameters of a control unit (e.g., a current flowing through a heater or a voltage applied across an electrode) based on the degree of deviation. Subsequently, the control unit operates under the determined operating parameters to enable a lens unit to possess a desired refractive index. Optionally, a correspondence between the degree of deviation from the setpoint and the operating parameters of the control unit can be calibrated through experiments, and can be stored in the form of a list in the microcontroller for invocation when determining the operating parameters.

As shown in FIG. 5, a microstructure 511 for interconnection with other computing modules is further disposed on the side surface of the substrate 510. The interconnection between computing modules will be further described below with reference to FIGS. 7 and 8.

In a variation of this embodiment, a piezoelectric-ceramic element or a shape-memory alloy can be adopted as the control unit. Specifically, the control unit 532 may be arranged around the collimating lens array 531. The microcontroller 580 changes a volume of the piezoelectric-ceramic element or the shape-memory alloy by controlling a voltage applied across or a current flowing through the piezoelectric-ceramic element or the shape-memory alloy based on the degree of deviation of a measured optical signal intensity from a setpoint, thereby changing a position of the collimating lens array 531 to achieve dynamic compensation for the loss of optical coupling efficiency.

FIG. 7 is a schematic diagram of computing module interconnection according to one embodiment of the present disclosure, where the interconnection mode as shown can be applied to the interconnection of the computing modules shown in FIG. 5. For the purpose of simplifying the description, only a partial cross-sectional structure of the computing modules is present here. Referring to FIG. 7, microstructures 711A and 711B adapted to be nested with each other are disposed on side surfaces of the substrates 710A and 710B of computing modules 70A and 70B, so that when the microstructures 711A and 711B are nested with each other, collimating lens arrays 731A and 731B of the computing modules 70A and 70B will be aligned with each other. The microstructures comprise, for example, but are not limited to, male-female connectors and magnetic attraction structures.

FIG. 8 is a schematic diagram of computing module interconnection according to one embodiment of the present disclosure, where the interconnection mode as shown can be applied to the interconnection of the computing modules shown in FIG. 5. Likewise, for the purpose of simplifying the description, only a partial cross-sectional structure of the computing modules is shown here. Referring to FIG. 8, a microstructure 811A adapted to be nested with a microstructure 811B of a fiber adapter unit 80B is disposed on a side surface of a substrate 810 of a computing module 80A. When the microstructures 811A and 811B are nested with each other, a collimating lens array 831A of the computing module 80A is aligned with a collimating lens array 831B of a fiber adapter unit 80B.

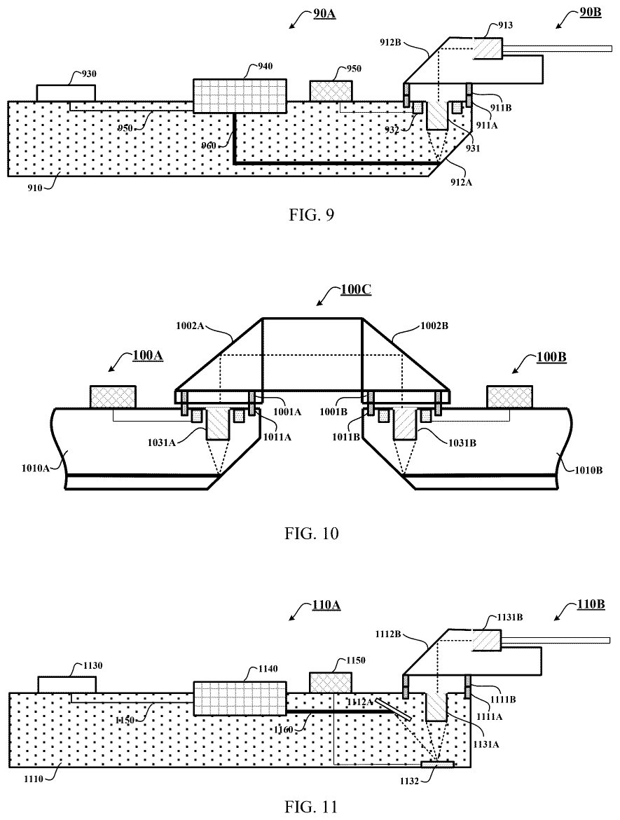

FIG. 9 is a schematic diagram of an optical connector according to one embodiment of the present disclosure. The optical connector as shown can be disposed, as a first optical connector, on the main surface of the substrate of the computing module described above.

In the computing module 90A shown in FIG. 9, optical signal transmission is implemented between a signal switching unit 940 and an optical connector 930 via an optical waveguide 960 and a reflective surface 912A, and electrical or optical signal transmission is implemented between the signal switching unit 940 and a signal processing unit 920 via a first transmission path 950. In this embodiment, a piezoelectric-ceramic element or a shape-memory alloy serves as the control unit 932. Referring to FIG. 9, the control unit 932 is arranged around a collimating lens array 931. It should be noted that the collimating lens array 931 comprises a plurality of lens units, and FIG. 9 shows only one of the lens units and its corresponding control unit. As shown in FIG. 9, a corresponding control unit is arranged around each of the lens units, thereby achieving adjustment of the position of a single lens unit. The microcontroller 950 can perform dynamic compensation for the loss of optical coupling efficiency in a manner similar to that shown in FIG. 6. Specifically, the microcontroller 950 determines a degree of deviation of an optical signal intensity from a setpoint based on a photocurrent signal at an optical coupling region of the signal switching unit 940, and determines operating parameters of a control unit 932 (e.g., a voltage applied across or a current flowing through the piezoelectric-ceramic element or the shape-memory alloy) based on the degree of deviation. Subsequently, a volume of the control unit 932 changes under the determined operating parameters, and in turn causes a position of the collimating lens array 931 to change as required.

Different from the embodiment shown in FIG. 5, a light-emitting surface or light-incident surface of the collimating lens array 931 is located on a main surface of the substrate 910. To enable light transmitted in the horizontally extending optical waveguide 960 to reach the collimating lens array 931 and light emitted from the collimating lens array 931 to reach the optical waveguide 960, as shown in FIG. 9, the bottom surface of the substrate 910 comprises a reflective surface 912A as a mirror, and light emitted from the optical waveguide 960 or the collimating lens array 931 (shown by the dashed lines in the figure) is guided to the collimating lens array 931 or the optical waveguide 960 after specular reflection. In a variation of this embodiment, the mirror is disposed at a suitable position inside the substrate 910 to implement light transmission between the optical waveguide 960 and the collimating lens array 931.

Further referring to FIG. 9, a microstructure 911A adapted to be nested with a microstructure 911B of a fiber adapter unit 90B is disposed on the main surface of the substrate 910 of the computing module 90A. When the microstructures 911A and 911B are nested with each other, the light emitted from the collimating lens array 931 or 913 (shown by the dashed lines in the figure) is reflected by a mirror 912B in the fiber adapter unit 90B and then reaches the collimating lens array 913 or 931.

FIG. 10 is a schematic diagram of computing module interconnection according to one embodiment of the present disclosure. For the purpose of simplifying the description, only a partial cross-sectional structure of the computing modules is shown here. Referring to FIG. 10, microstructures 1011A and 1011B are disposed on a main surfaces of the substrates 1010A and 1010B near a position of a light-emitting or light-incident surface of a collimating lens array. A bridge component 100C, as a detachable component independent of computing modules 100A and 100B, comprises microstructures 1001A and 1001B and mirror surfaces 1002A and 1002B. When the microstructures 1011A and 1011B are nested with the microstructures 1001A and 1001B respectively, light emitted from the collimating lens array 1031A or 1031B of the computing module 100A or 100B (shown by the dashed lines in the figure) is reflected by the mirror surfaces 1002A and 1002B and reaches the collimating lens array 1031B or 1031A of the computing module 100B or 100A.

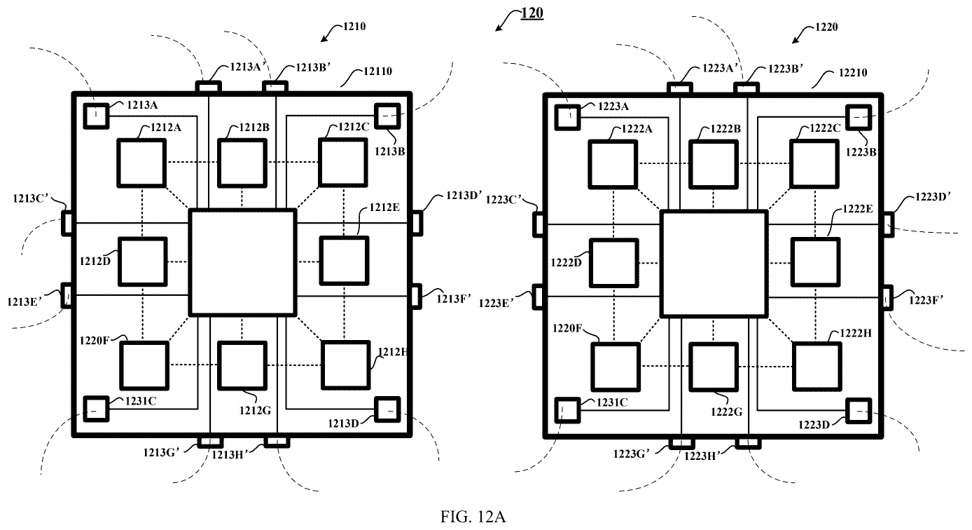

FIG. 11 is a schematic diagram of an optical connector according to one embodiment of the present disclosure. The optical connector shown can be disposed, as a first optical connector, on the main surface of the substrate of the computing module described above.

In a computing module 110A shown in FIG. 11, electrical or optical signal transmission is implemented between a signal switching unit 1140 and a signal processing unit 1120 via a first transmission path 1150. Different from the embodiments shown in FIGS. 5 and 7-10, in this embodiment, the control unit 1132 per se is a component of an optical signal transmission path. Specifically, as shown in FIG. 11, the control unit 1132 is located between an optical waveguide 1160 and a collimating lens array 1131A and serves to deflect light rays. Light from the optical waveguide 1160 reaches the control unit 1132 after specular reflection by a mirror 1112A disposed inside a substrate 1110A, and is then guided to the collimating lens array 1131A by the control unit 1132. On the other hand, light from the collimating lens array 1131A is guided by the control unit 1132 to the mirror 1112A, and is then reflected to the optical waveguide 1160. In this embodiment, a deflection angle of the control unit 1132 is adjustable, so that the propagation direction of light between the control unit 1132 and the collimating lens array 1131A can be controlled to allow more light to enter the optical waveguide or the collimating lens array. As a specific example, the control unit 1132 can be enabled using an optical element such as a MEMS mirror or a phase-only liquid crystal on silicon.

A microcontroller 1150 also performs dynamic compensation for the loss of optical coupling efficiency in a manner similar to that shown in FIG. 6. For example, in the case where the control unit 1132 is a MEMS mirror, the microcontroller 1150 determines a degree of deviation of an optical signal intensity from a setpoint based on a photocurrent signal at an optical coupling region of the signal switching unit 1140, and determines a deflection angle of the MEMS mirror based on the degree of deviation, so as to control the propagation direction of light by causing the MEMS mirror to have the determined deflection angle. As another example, in the case where the control unit 1132 is a phase-only liquid crystal on silicon, the microcontroller 1150 determines a degree of deviation of the optical signal intensity from a setpoint based on the photocurrent signal at the optical coupling region, and determines a phase distribution of liquid-crystal molecules in the phase-only liquid crystal on silicon based on the degree of deviation, so as to improve the optical coupling efficiency by adjusting the phase distribution of the liquid-crystal molecules to cause the light to propagate along a desired direction.

In this embodiment, the control unit 1132 comprises a plurality of control elements, and each lens unit of the collimating lens array 1131A is equipped with a corresponding control element (only one lens unit and its corresponding control element are shown in the figure), so that separate control over the light propagation direction between each of the lens units and the control element can be achieved.

Further referring to FIG. 11, a microstructure 1111A adapted to be nested with a microstructure 1111B of a fiber adapter unit 110B is disposed on the main surface of a substrate 1110 of the computing module 110A. When the microstructures 1111A and 1111B are nested with each other, the light emitted from the collimating lens array 1131A or 1131B is reflected by a mirror 1112B in the fiber adapter unit 110B and then reaches the collimating lens array 1131B or 1131A.

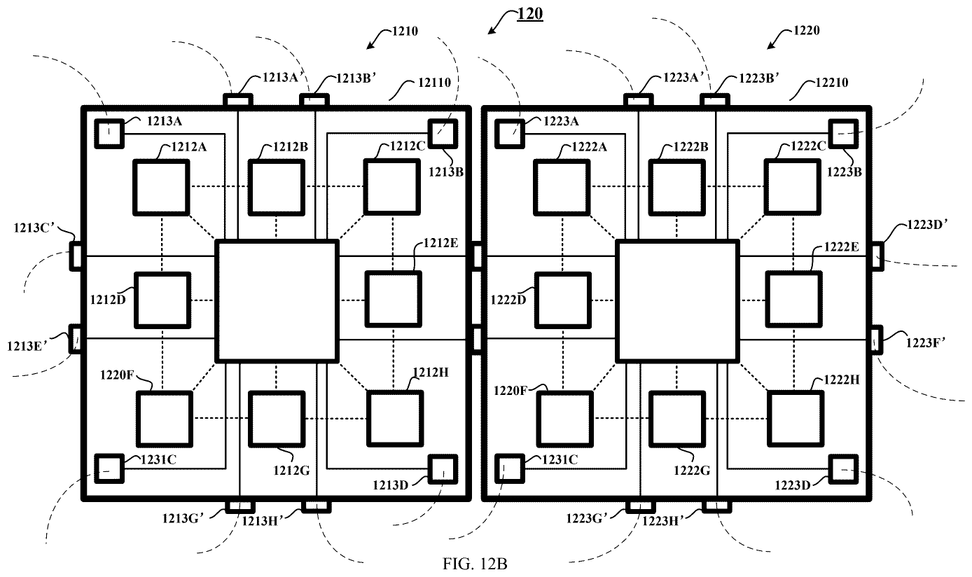

FIGS. 12A and 12B are schematic diagrams of a computing apparatus according to one embodiment of the present disclosure, wherein FIG. 12A illustrates the state of the computing apparatus as shown before interconnection, and FIG. 12B illustrates the state of the computing apparatus as shown after interconnection.

The computing apparatus 120 shown in FIGS. 12A and 12B comprises computing modules 1210 and 1220. Each computing module can have the various features of the embodiments described above with reference to the accompanying drawings. In addition, each computing module can also have a combination of the above various features, provided that no contradictions arise.

Taking the computing module 1210 as an example, in some specific implementations, the computing module 1210 can comprise a substrate 1211, data processing units 1212A-1212H, first optical connectors 1213A-1213D, second optical connectors 1213A′-1213H′, and a signal switching unit 1214. In particular, as shown in FIGS. 12A and 12B, the second optical connectors 1213D′ and 1213F′ of the computing module 1210 and second optical connectors 1223C′ and 1223E′ of the computing module 1220 are enabled in the form of direct-connect optical connectors. Accordingly, the computing modules 1210 and 1220 can be connected together via these second optical connectors to implement data communication between the two computing modules, thereby forming a computing apparatus comprising a plurality of computing modules. In addition, as shown in the figures, the other optical connectors adopt a structure suitable for connection with a fiber adapter unit, so that the computing modules 1210 and 1220 can be interconnected with other computing modules via optical fibers (shown as dashed arcs in the figures) to build a larger-scale computing apparatus. Since the signal transmission between the computing modules is optical signal transmission, the computing apparatus currently and hereinafter described is also referred to as an optical interconnect system.

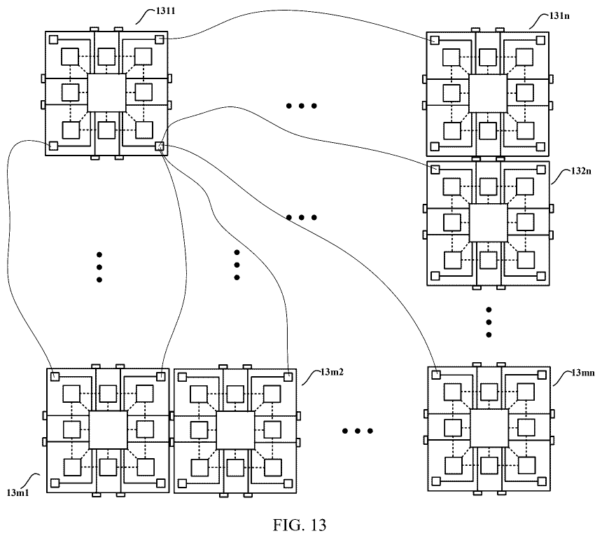

FIG. 13 is a schematic diagram of a computing apparatus or an optical interconnect system according to one embodiment of the present disclosure. A computing apparatus 130 shown in FIG. 13 comprises a plurality of computing modules 1311-13mn (where m and n are the number of rows and the number of columns, respectively). Each computing module can have the various features of the embodiments described above with reference to the accompanying drawings. In addition, each of the computing modules can also have a combination of the above various features, provided that no contradictions arise.

Exemplarily, as shown in FIG. 13, a plurality of computing modules 1311-13mn are arranged in an m×n matrix form, and adjacent computing modules can be connected via one or more second optical connectors disposed on their respective side surfaces and implemented in the form of direct-connect optical connectors to implement data communication therebetween. Furthermore, non-adjacent computing modules can be selectively connected via one or more first optical connectors disposed on their respective main surfaces and having a structure suitable for connection with a fiber adapter unit to implement data communication therebetween. For instance, in the example shown in FIG. 13, the computing module 1311 and 131n are optically interconnected by means of two first optical connectors, the computing module 1311 and 13m1 are optically interconnected by means of two first optical connectors, and the computing module 1311 is simultaneously optically interconnected with the computing modules 132n, 13m1, 13m2, and 13mn by means of a single first optical connector that it comprises.

Those skilled in the art will understand that the various illustrative logical blocks, modules, circuits and algorithm steps described herein can be implemented as electronic hardware, computer software or a combination of both.

To illustrate this interchangeability of hardware and software, various illustrative components, blocks, modules, circuits and steps are described above generally in terms of their functionality. Whether such functionality is implemented as hardware or software depends upon the particular application and design constraints imposed on the overall system. Those skilled in the art can implement the described functionality in varying ways for each particular application, but such implementation decisions should not be interpreted as causing a departure from the scope of the present disclosure.

Although only certain specific embodiments of the present disclosure are described, those of ordinary skill in the art should understand that the present disclosure can be implemented in many other forms without departing from its spirit and scope. Therefore, the presented examples and embodiments are to be deemed illustrative, rather than restrictive, and the present disclosure may encompass various modifications and replacements without departing from the spirit and scope of the present disclosure as defined by the appended claims.

The embodiments and examples set forth herein are provided to best illustrate the embodiments of the present technology and its particular applications, and thereby to enable those skilled in the art to implement and use the present disclosure. Nevertheless, those skilled in the art will know that the above description and examples are furnished for illustrative and exemplary purposes solely. The presented description is not intended to be exhaustive or to limit the present disclosure to the precise form disclosed.

What is claimed is:

1. A computing module, comprising:
a substrate;
a plurality of data processing units disposed on a surface of or inside the substrate;
one or more optical connectors disposed on the surface of the substrate; and
a signal switching unit disposed on the surface of or inside the substrate, the signal switching unit being connected to the plurality of data processing units via a first transmission path to implement a first signal transmission between the signal switching unit and the plurality of data processing units, and being connected to the one or more optical connectors via a second transmission path to implement a second signal transmission between the signal switching unit and the one or more optical connectors,
wherein the first signal transmission is electrical signal transmission or optical signal transmission, and the second signal transmission is optical signal transmission.

2. The computing module of claim 1, wherein each of the plurality of data processing units comprises one or more of the following: a computing chip, a memory chip, and an in-memory computing chip.

3. The computing module of claim 2, wherein the signal switching unit comprises an optical-switching chip, each of the plurality of data processing units further comprises an optoelectronic converter chip, and the optoelectronic converter chip being configured to convert an optical signal from the optical-switching chip into an electrical signal suitable for processing by the computing chip, the memory chip, and the in-memory computing chip, and to convert an electrical signal from the plurality of data processing units into an optical signal suitable for processing by the optical-switching chip.

4. The computing module of claim 3, wherein the first transmission path and the second transmission path are optical waveguides disposed inside the substrate.

5. The computing module of claim 2, wherein the signal switching unit is configured to convert an optical signal from the optical connectors into an electrical signal suitable for processing by the plurality of data processing units, and to convert an electrical signal from the plurality of data processing units into an optical signal suitable for processing by the optical connectors.

6. The computing module of claim 5, wherein the signal switching unit is a photonic integrated circuit integrating an optoelectronic conversion function and an optical switching function.

7. The computing module of claim 5, wherein the first transmission path is a high-speed circuit disposed on the surface of or inside the substrate, and the second transmission path is an optical waveguide disposed inside the substrate.

8. The computing module of claim 1, wherein the signal switching unit is located at a center of a main surface of the substrate, and the plurality of data processing units are located around a periphery of the signal switching unit.

9. The computing module of claim 1, wherein the optical connectors are located on a main surface or a side surface of the substrate.

10. The computing module of claim 1, wherein adjacent data processing units of the plurality of data processing units are interconnected via a third transmission path to implement a third signal transmission between the adjacent data processing units, the third signal transmission being electrical signal transmission or optical signal transmission.

11. The computing module of claim 1, wherein the second transmission path is an optical waveguide disposed inside the substrate, the one or more optical connectors comprise a collimating lens array in optical connection with the optical waveguide and a control unit disposed near the collimating lens array, and the computing module further comprises a microcontroller disposed on the surface of or inside the substrate, the microcontroller being configured to, based on an optical signal intensity measured at the signal switching unit, adjust a refractive index or a position of the collimating lens array via the control unit to improve an optical coupling efficiency between the optical waveguide and the one or more optical connectors.

12. The computing module of claim 11, wherein each lens unit of the collimating lens array is made of a polymer material having an electro-optic property or a thermo-optic property, the control unit is an electrode or a heater, and the microcontroller adjusts the refractive index of the collimating lens array by controlling a current flowing through the heater or a voltage applied across the electrode, based on a degree of deviation of the measured optical signal intensity from a setpoint.

13. The computing module of claim 11, wherein the control unit is a piezoelectric-ceramic element or a shape-memory alloy, and the microcontroller adjusts the position of the collimating lens array by controlling a voltage applied across or a current flowing through the piezoelectric-ceramic element or the shape-memory alloy, based on a degree of deviation of the measured optical signal intensity from a setpoint.

14. The computing module of claim 1, wherein the second transmission path is an optical waveguide disposed inside the substrate, the one or more optical connectors comprise a control unit and a collimating lens array in optical connection with the optical waveguide via the control unit, and the computing module further comprises a microcontroller disposed on the surface of or inside the substrate, the microcontroller being configured to, based on an optical signal intensity measured at the signal switching unit, control a propagation direction of light between the control unit and the collimating lens array by means of the control unit to improve an optical coupling efficiency between the optical waveguide and an optical interconnect unit.

15. The computing module of claim 14, wherein the control unit is a MEMS mirror, and the microcontroller is configured to control the propagation direction by adjusting a deflection angle of the MEMS mirror, based on a degree to which the measured optical signal intensity is lower than a setpoint.

16. The computing module of claim 14, wherein the control unit is a phase-only liquid crystal on silicon, and the microcontroller is configured to control the propagation direction by adjusting a phase distribution of liquid-crystal molecules in the phase-only liquid crystal on silicon, based on a degree to which the measured optical signal intensity is lower than a setpoint.

17. A computing apparatus, comprising a plurality of computing modules, wherein each of the computing modules comprises:
a substrate;
a plurality of data processing units disposed on a surface of or inside the substrate;
one or more optical connectors disposed on the surface of the substrate and connected to optical connectors of other computing modules; and
a signal switching unit disposed on the surface of or inside the substrate, the signal switching unit being connected to the plurality of data processing units via a first transmission path to implement a first signal transmission between the signal switching unit and the plurality of data processing units, and being connected to the one or more optical connectors via a second transmission path to implement a second signal transmission between the signal switching unit and the one or more optical connectors, wherein the first signal transmission is electrical signal transmission or optical signal transmission, and the second signal transmission is optical signal transmission.

18. The computing apparatus of claim 17, wherein each of the plurality of data processing units comprises one or more of the following: a computing chip, a memory chip, and an in-memory computing chip.

19. The computing apparatus of claim 18, wherein the signal switching unit comprises an optical-switching chip, and each of the plurality of data processing units further comprises an optoelectronic converter chip, the optoelectronic converter chip being configured to convert an optical signal from the optical-switching chip into an electrical signal suitable for processing by the computing chip, the memory chip, and the in-memory computing chip, and to convert an electrical signal from the plurality of data processing units into an optical signal suitable for processing by the optical-switching chip.

20. The computing apparatus of claim 19, wherein the first transmission path and the second transmission path are optical waveguides disposed inside the substrate.

21. The computing apparatus of claim 18, wherein the signal switching unit is an optoelectronic switching chip configured to convert an optical signal from the optical connectors into an electrical signal suitable for processing by the plurality of data processing units, and convert an electrical signal from the plurality of data processing units into an optical signal suitable for processing by the optical connectors.

22. The computing apparatus of claim 21, wherein the signal switching unit is a photonic integrated circuit integrating an optoelectronic conversion function and an optical switching function.

23. The computing apparatus of claim 21, wherein the first transmission path is a high-speed circuit disposed on the surface of or inside the substrate, and the second transmission path is an optical waveguide disposed inside the substrate.

24. The computing apparatus of claim 17, wherein adjacent data processing units of the plurality of data processing units are interconnected via a third transmission path to implement a third signal transmission between the adjacent data processing units, the third signal transmission being electrical signal transmission or optical signal transmission.

25. The computing apparatus of claim 17, wherein the optical connectors are located on a main surface or a side surface of the substrate.
